(19) United States
(12) Patent Application Publication
(10) Pub. No.: US 2026/0011181 A1
(43) Pub. Date: Jan. 8, 2026

(54) METHOD, APPARATUS, AND COMPUTER PROGRAM PRODUCT FOR IMAGE AUTHENTICATION AND SAME FOR PROVIDING AN IMAGE AUTHENTICATOR

(71) Applicant: Candour Oy, Oulu (FI)

(72) Inventor: Zinelabidine BOULKENAFET, Oulu (FI)

(21) Appl. No.: 18/992,517

(22) PCT Filed: Jul. 6, 2023
(86) PCT No.: PCT/FI2023/050431

§ 371 Date: Jan. 8, 2025

(30) Foreign Application Priority Data
Jul. 8, 2022 (FI) 20225645

(51) Int. Cl. G06V 40/40; G06V 10/774; G06V 10/82; G06V 40/16; G06V 40/18

(52) U.S. Cl. CPC G06V 40/40; G06V 10/774; G06V 10/82; G06V 40/172; G06V 40/197

(57) ABSTRACT

A method, apparatus, and computer program product for image authentication, and same for providing an image authenticator are disclosed. The method for image authentication comprises: obtaining image data encoded in a first color space; transforming the image data to a second color space using a color transformation block, wherein the color transformation block has been trained, using training image data comprising a plurality of training images, as part of a neural network configured to classify each training image of the training image data as authentic or fraudulent; classifying the transformed image data as authentic or fraudulent; and outputting the authentic or fraudulent classification of the image data.

### TECHNICAL FIELD

The present solution generally relates to a method, an apparatus, and a computer program product for image authentication, and same for providing an image authenticator.

### BACKGROUND

Biometric identification and identity verification are subject to various kinds of presentation attacks, also known as spoofing attacks. To detect such attacks, image authentication is an integral component of many biometric identification systems. Image authentication refers to evaluation of the structure and content of images to determine whether the image is authentic. For example, indicators of image manipulation or staging may suggest that the image is not authentic and raise suspicion of a presentation attack.

Static two-dimensional attacks employ photographs or pictures presented on a display. Dynamic two-dimensional attack schemes employ sequences of video replayed on a display or injected as an input from a virtual camera. Rigid three-dimensional attacks utilize 3D printer reproductions of faces, and flexible three-dimensional attacks can be implemented using latex masks or make-up, for example. Despite development of increasingly sophisticated and expensive anti-spoofing technologies, there is still room for improvement regarding the performance of said technologies.

### SUMMARY OF THE INVENTION

The scope of protection sought for various embodiments of the invention is set out by the independent claims. Various embodiments are disclosed in the dependent claims. The embodiments and features, if any, described in this specification that do not fall under the scope of the independent claims are to be interpreted as examples useful for understanding various embodiments of the invention.

### BRIEF DESCRIPTION OF THE DRAWINGS

FIG. 1 illustrates example scenarios and embodiments of a system for image authentication;

FIG. 2 is a schematic diagram depicting embodiments of an apparatus;

FIG. 3 is a flow chart illustrating embodiments of a method for image authentication;

FIG. 4 is a flow chart illustrating embodiments of a method for providing an image authenticator; and

FIG. 5 and FIG. 6 illustrate embodiments of neural networks.

### DETAILED DESCRIPTION OF THE INVENTION

The following description and drawings are illustrative and are not to be construed as unnecessarily limiting. The specific details are provided for a thorough understanding of the disclosure. However, in certain instances, well-known or conventional details are not described in order to avoid obscuring the description. In this specification, reference to “one embodiment” or “an embodiment” means that a particular feature, structure, or characteristic described in connection with the embodiment is included in at least one embodiment of the disclosure. References to an embodiment can be, but are not necessarily, references to the same embodiment in the present disclosure.

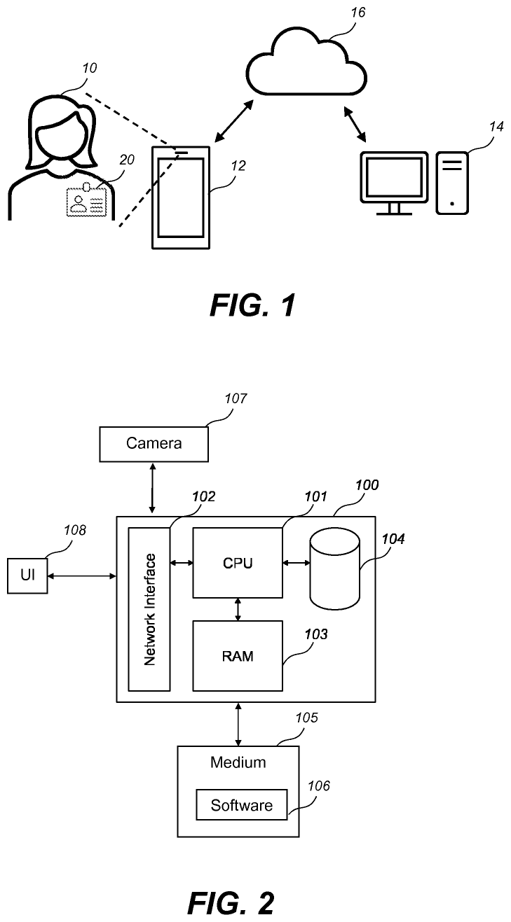

FIG. 1 illustrates example scenarios and a system for image authentication. The system may comprise a user device 12 and a server 14. The user device 12 is a computing device, and the server is another computing device that is connectable to the user device via a network 16. The user device 12 may be a personal computer, a mobile device, such as a smartphone, tablet computer, laptop, smart watch, or another mobile computing device. A user 10 may wish to (biometrically) identify themselves to perform an action using the user device 12 and/or the server 14, and/or to gain access to an application or to data stored in the user device 12 and/or the server 14. Identification or identity verification may be passed using e.g., an identifier (ID) document, such as an ID card 20 issued to the user. Biometric identification may be passed using a biometric sample, such as the face of the user. Some systems may require both an ID document and a biometric sample to be presented in order to pass identification or identity verification for increased security.

For example, the user may wish to sign a document or attend an online exam using an ID card as an identifier, and/or their face as a biometric sample to prove their identity. The user 10 may use a camera of the user device 12 to take a photo or video of their face and/or the ID card 20, and the photo/video may be analyzed to identify or verify the identity of the user. To prevent unauthorized parties from identifying as the user 10, image authentication techniques may be performed to distinguish the real images of the user 10 and/or the ID card from presentation attacks.

As another example, when the user 10 wishes to access an application on the user device 12, image authentication may be performed by the user device 12 alone on the basis of the photo/video captured by the user 10 using the user device 12. If the identification or identity verification and image authentication succeed, the user device allows the user 10 to access the application with the user device 12.

In another example, the user wishes to identify themselves to gain access to a building. The user device 12 executing an access control application may send the results of the identification or identity verification and image authentication to the server 14 executing an access control program, and the server 14 executing the access control program may grant the user 10 access to the building e.g. by sending a command to unlock an electric lock of a door of the building.

In another example, the user wishes to attend an online exam that uses biometric invigilation. The user device 12, being e.g., a personal computer or laptop of the user, may send video captured by an integrated or external camera to the server 14. The server 14 may perform the identification or identity verification and image authentication, and grant the user access to an exam platform executing on the server 14.

In another example, the user wishes to sign a document using their face as a biometric sample and a passport as an identifier document. The user device may send photo/video data of the user's face and the passport, captured by the user device 12, to the server 14.

The server 14 may perform the identification or identity verification and image authentication, and send the results of the identification or identity verification and image authentication to the user device 12. The user device 12 may receive the results and allow the user to sign a document using the user device 12.

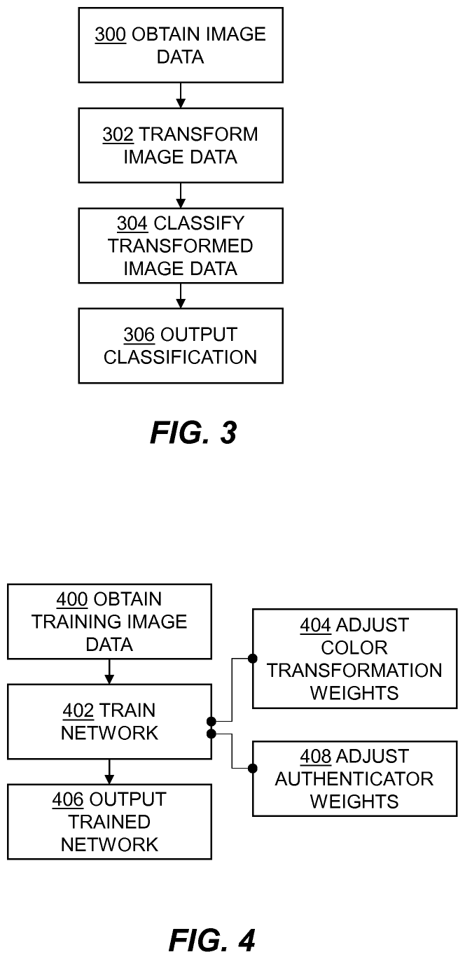

FIG. 2 is a schematic diagram depicting embodiments of an apparatus 100. The apparatus 100 may perform the method of FIG. 3, or the method of FIG. 4. The apparatus 100 of FIG. 2 may be a general-purpose computer, such as the server 14 of FIG. 1. Alternatively, the apparatus may be the user device 12 of FIG. 1. The apparatus 100 may include at least one processor 101, such as a central processing unit (CPU) and/or a graphics processing unit (GPU). The apparatus 100 may include at least one memory 103, 104, such as random access memory (RAM) 103, and/or non-volatile memory 104. The apparatus may be but need not be dedicated hardware. The apparatus may be a virtual machine. Either one of the methods, described in more detail below, may be executed as a containerized application using operating system (OS)-level virtualization.

The apparatus 100 may comprise a network interface 102 for communicating with other devices via a network. The apparatus 100 may be located in a data center and accessible via the network through the network interface 102. The network interface may comprise one or more network interfaces, such as a cellular network interface, an Internet of Things (IoT) network interface, a personal area network (PAN) interface, and other suitable network interfaces.

FIG. 3 is a flow chart depicting embodiments of a (computer-implemented) method for image authentication. The method of FIG. 3 may be performed by the user device 12 of FIG. 1. Alternatively, the method of FIG. 3 may be performed by the server 14 of FIG. 1. The method of FIG. 3 comprises obtaining 300 image data encoded in a first color space; transforming 302 the image data to a second color space using a color transformation block, wherein the color transformation block has been trained, using training image data comprising a plurality of training images, as part of a neural network configured to classify each training image of the training image data as authentic or fraudulent; classifying 304 the transformed image data as authentic or fraudulent; and outputting 306 the authentic or fraudulent classification of the image data.

Technical effects of the invention include improvements in image authentication performance. Use of the color transformation block that has been acquired using machine learning (ML) methods may improve the specificity and/or sensitivity of classifying images as either authentic or fraudulent. Further, as the classification performance may be improved, computationally expensive classifiers may be replaced by simpler classifiers with worse classification performance. When such classifiers are used with the color transformation block, improved computational performance may be achieved while at least maintaining the classification performance.

As mentioned above, the apparatus 100 of FIG. 2 may be configured to perform the method of FIG. 3 or any of its embodiments. The apparatus 100 may comprise means for performing the method of FIG. 3 or any of its embodiments. According to an aspect, the apparatus 100 for image authentication comprises at least one processor 101, at least one memory 103, 104 including computer program code, the at least one memory 103, 104 and the computer program code configured to, with the at least one processor 101, cause the apparatus 100 to perform the method of FIG. 3 or any of its embodiments. The apparatus 100 may be the user device 12 or the server 14 of FIG. 1.

Referring again to FIG. 2, a computer program product or a computer-readable medium 105 for image authentication comprises computer program code 106 configured to, when executed by at least one processor 101, cause an apparatus 100 or a system to perform the method of FIG. 3 or any of its embodiments. In an embodiment, the computer-readable medium is a non-transitory computer-readable medium.

The method of FIG. 3 comprises obtaining 300 image data encoded in a first color space. In an embodiment, the obtaining comprises measuring the image data e.g., by the camera 107 illustrated in FIG. 2. In an embodiment, the apparatus 100 comprises the camera 107 configured to measure the image data, or video data from which the image data is extracted as a part of the obtaining. The camera may be configured to measure, and/or the image data may comprise visible spectrum image data, ultraviolet image data, infrared image data, near-infrared image data, and/or thermal image data. For example, in an embodiment, the image data comprises visible spectrum image data and near-infrared image data. This may allow for better authentication of biometric samples of dark-skinned individuals. For example, the image data may comprise visible spectrum image data in red, green, and blue (RGB) channels, and infrared image data in an infrared channel. As another example, the blue channel of RBG image data may be replaced with the infrared channel such that the image data may comprise visible spectrum image data in the red and green channels, and infrared image data in the infrared channel.

Alternatively, or additionally, the obtaining may comprise reading the image data from the at least one memory of the apparatus. When the apparatus is the server 14 of FIG. 1, the obtaining may comprise receiving the image data from the user device 12. The user device 12 may acquire the image data e.g., using its camera, and transmit the image data to the server 14 e.g., via the network 16 and/or by a network interface of the user device 12. The server 14 may receive the image data via the network 16 and/or by a network interface of the server 14.

The image data is encoded or represented in a first color space or according to a first color model. A color space or color model defines a way of encoding colors e.g., as tuples of values. The encoded values represent different aspects of the encoded color such as hue, chroma, saturation, brightness, lightness, and/or luminosity. The first color space may be RGB, RGBA, any International Commission on Illumination (CIE) color space such as CIEXYZ, CIERGB, CIELUV, CIEUVW, or CIELAB, YIQ, YUV, YDbDr, YPbPr, YCbCr, xvYCC, ICtCp, HSV, HSL, HIS, RG Chromaticity, TSL, or any other color space other than the second color space.

The image data depicts an authentic or a fraudulent image. In an embodiment, the image data is biometric image data depicting a biometric sample. Correspondingly, each training image used to train the color transformation block may depict an authentic or a fraudulent biometric sample. The biometric sample may be a biometric sample of a human subject. The biometric sample may be or comprise a face, iris, or retina of the subject, for example. Alternatively, or additionally, the image data may depict an identifier document of the human subject, such as an ID card.

The method of FIG. 3 further comprises transforming 302 the image data to a second color space using a color transformation block. The second color space is different from the first color space. The second color space may not be any of the above-mentioned color spaces; it is a unique color space that has been obtained by training an artificial neural network as described later herein. The second color space may be defined by the color transformation block, which provides a transformation function from one of the above-mentioned color spaces, i.e., the first color space, to the second color space.

The color transformation block used in the method of FIG. 3 has been trained, using training image data comprising a plurality of training images, as part of a neural network configured to classify each training image of the training image data as authentic or fraudulent. The color transformation block and the neural network have been trained using artificial intelligence (AI) methods, ML methods, and/or deep learning (DL) methods, and details of how the training has been performed are described later in this document.

In an embodiment, the transforming 302 comprises applying one or more linear transformations to each pixel of the image data. The same linear transformation(s) may be applied to each pixel of the image data. Correspondingly, the color transformation block may comprise the linear transformation(s). For example, when the first color space is the RGB color space, a linear transformation for obtaining a value C for a first channel of the second color space may be

$$C = aR + bG + cB \qquad ( 1 )$$

wherein R, G, and B represent values of the image data in the red, green and blue channels of a pixel of the image data, and a, b, and c represent weights or coefficients determined during the training of the color transformation block/neural network. The linear transformation(s) may comprise further equations, formulas or transformations to be applied to the image data values to obtain transformed values for further channels of the second color space. Linear transformations are readily applicable to and convenient to obtain from convolutional neural networks. Alternatively, or additionally, the transforming comprises applying one or more nonlinear transformations to each pixel of the image data.

In an embodiment, a number of channels of the second color space is greater than or equal to a number of channels of the first color space. For example, when the first color space is a 3-channel color space such as RGB or HSV, the second color space may have 3, 4, 5, 6, or more channels. Preserving or increasing the number of channels may allow for extracting more information from the image data, which may improve the classification performance.

The method of FIG. 3 further comprises classifying 304 the transformed image data as authentic or fraudulent. The classifying may be performed by any suitable classifier, including artificial (convolutional) neural networks such as a residual neural network (ResNet) or a “VGG” neural network by the Oxford University Visual Geometry Group, or a Vision Transformer (ViT). Alternatively, the classifier may be a non-AI, non-ML, and/or non-DL classifier, such as a local binary pattern (LBP) based classifier. When the classifier is a ML classifier, the classifier may be taught using image data encoded in the second color space to ensure compatibility with the color transformation block.

In an embodiment, the classifying is performed by the neural network that was used to train the color transformation block. For this purpose, the neural network may comprise a classifier, such as an authenticator block configured to classify the image data as authentic or fraudulent. When the classification is performed by the same neural network as the training of the color transformation block, compatibility of the color transformation block and the classifier is ensured, improving the reliability of the classification. Further, the color transformation block may be optimized for use with the classifier in question, i.e., the neural network.

In an embodiment, the classifying is performed by a second neural network trained to classify image data as authentic or fraudulent, wherein the second neural network has been trained separately from the neural network. The neural network and the second neural network may have been trained using the same or different training image data. The training of the first neural network may have been performed independently of the training of the second neural network. Benefits of using a separately trained classifier include that both the color transformation block and the second neural network may each have been optimized for their respective purposes. Further, the color transformation block may have been trained with a computationally simple classifier with a poorer classification performance than that of the second neural network, saving computational resources when training the color transformation block.

The method of FIG. 3 further comprises outputting 306 the authentic or fraudulent classification of the image data. The outputting may comprise writing the classification to the at least one memory of the apparatus. Alternatively, or additionally, the outputting may comprise transmitting the classification e.g., via the network 16 (see FIG. 1) and/or by the network interface 102 (see FIG. 2). For example, when the method is performed by the server 14 of FIG. 1, the server 14 may transmit the classification to the user device 12 e.g., via the network 16 and/or by a network interface of the server 14. The user device 12 may receive the classification via the network 16 and/or by a network interface of the user device 12. Alternatively, when the method is performed by the user device 12, the user device 12 may transmit the classification to the server 14 e.g., via the network 16 and/or by a network interface of the user device. The server 14 may receive the classification via the network 16 and/or by a network interface of the server 14.

In an embodiment, the apparatus 100 of FIG. 2 or the system of FIG. 1 comprises an interface configured to output the authentic or fraudulent classification. The interface may be the above-mentioned network interface, and/or the interface may be a user interface 108 as shown in FIG. 2. The user interface may comprise e.g., a display, a speaker, and/or a haptic output device configured to output the authentic or fraudulent classification.

Let us now describe how the color transformation block and the neural network may have been trained with reference to a (computer-implemented) method for providing an image authenticator, illustrated in FIG. 4. The method of FIG. 4 may be performed by the server 14 of FIG. 1. Alternatively, the method of FIG. 4 may be performed by another apparatus not illustrated in FIG. 4. The method of FIG. 4 comprises obtaining 400 training image data comprising a plurality of training images, wherein the training image data is encoded in a first color space; training 402 a neural network using the training image data, wherein the neural network comprises: a color transformation block configured to cause a color transformation from the first color space to a second color space, and an authenticator block configured to classify each training image of the training image data as authentic or fraudulent; wherein the training comprises adjusting 404, 408 weights of the color transformation block and the authenticator block of the neural network; and outputting 406 the trained neural network.

The method of FIG. 4 provides a neural network that may be used to achieve improvements in image authentication performance. The neural network may be used for image authentication as such, or the color transformation block may be extracted from the neural network and combined with another classifier, including AI, ML, DL, non-AI, non-ML, and non-DL classifiers. As discussed above, use of the color transformation block of the neural network may improve the classification performance, specificity and/or sensitivity of classifying images as either authentic or fraudulent.

As mentioned above, the apparatus 100 of FIG. 2 may be configured to perform the method of FIG. 4 or any of its embodiments. The apparatus 100 may comprise means for performing the method of FIG. 4 or any of its embodiments. According to an aspect, the apparatus 100 of FIG. 2 for providing an image authenticator comprises at least one processor 101, at least one memory 103, 104 including computer program code, the at least one memory 103, 104 and the computer program code configured to, with the at least one processor 101, cause the apparatus 100 to perform the method of FIG. 4 or any of its embodiments. The apparatus 100 may be the server 14 of FIG. 1.

Referring again to FIG. 2, a computer program product or a computer-readable medium 105 for providing an image authenticator comprises computer program code 106 configured to, when executed by at least one processor 101, cause an apparatus 100 or a system to perform the method of FIG. 4 or any of its embodiments. In an embodiment, the computer-readable medium is a non-transitory computer-readable medium.

The method of FIG. 4 comprises obtaining 400 training image data comprising a plurality of training images. The training image data may comprise visible spectrum image data, ultraviolet image data, infrared image data, near-infrared image data, and/or thermal image data. The type or content of the training image data may correspond to that of the image data discussed earlier. The obtaining may comprise reading the training image data from the at least one memory of the apparatus. Alternatively, or additionally, the obtaining may comprise receiving the training image data. When the apparatus is the server 14 of FIG. 1, the obtaining may comprise receiving the image data via the network 16 and/or by a network interface of the server 14. The training image data is encoded in the first color space, examples of which have been discussed earlier in this document.

The training image data may depict authentic images and/or fraudulent images. In an embodiment, the training image data is biometric image data. Each training image of the training image data used to train the color transformation block may depict an authentic or a fraudulent biometric sample. As discussed above, the biometric sample may be a face, iris, or retina, of a human subject, for example. Alternatively, or additionally, the training image data may depict identifier documents, such as ID cards. Each training image used to train the color transformation block may depict an authentic ID, such as a real ID card, or a fraudulent ID, such as a copy of the ID card printed on paper.

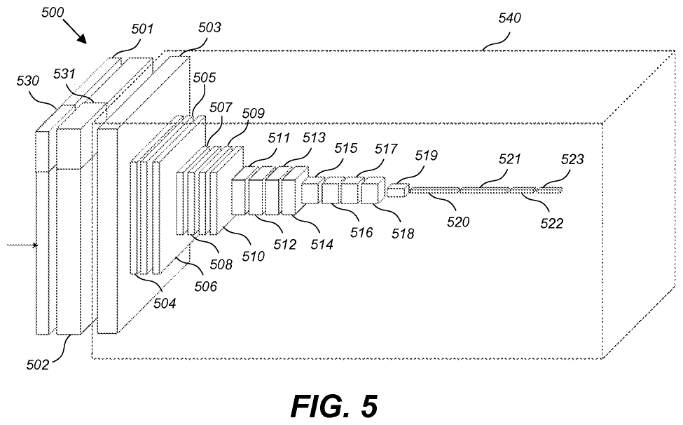

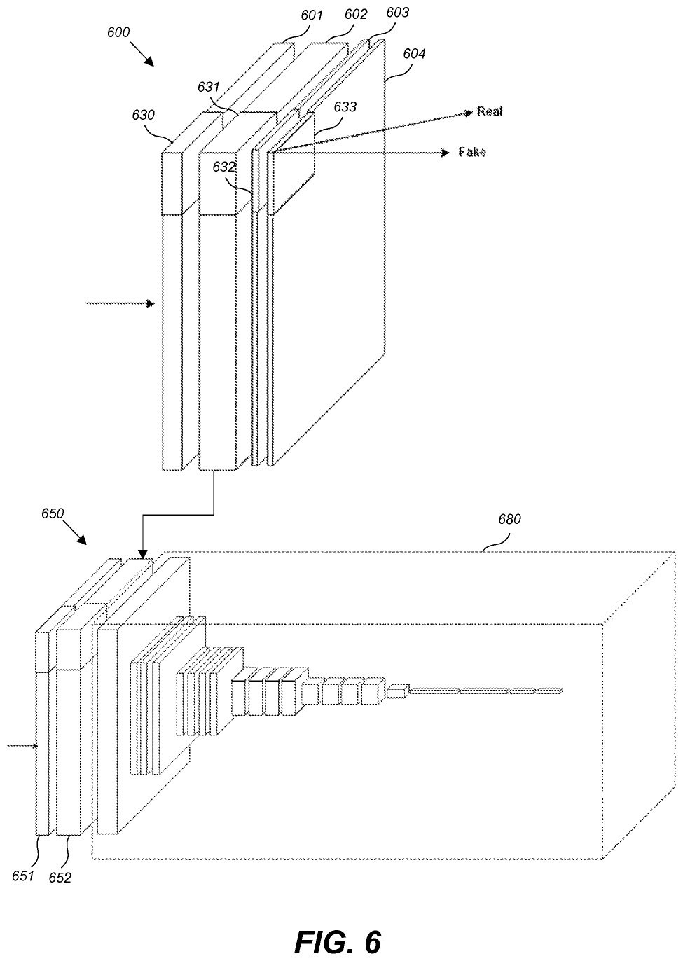

The method of FIG. 4 further comprises training 402 a neural network using the training image data. The neural network is configured to classify the (training) image data as authentic or fraudulent. The neural network may be any kind of artificial neural network, such as a feedforward neural network, a convolutional neural network, a deep neural network, a deep stacking network, a deep belief network, and/or a recurrent neural network. The neural network trained according to the method of FIG. 4 comprises a color transformation block configured to cause a color transformation from the first color space to a second color space, and an authenticator block (or a classifier) configured to classify each training image of the training image data as authentic or fraudulent. Some examples and embodiments of neural networks are illustrated in FIG. 5 and FIG. 6.

As is known in the art, neural networks comprise artificial neurons that are typically organized into layers. Neurons of one layer are connected to neurons of the immediately preceding and immediately following layers. Weights for the neurons and/or the connections between the neurons are adjusted when training the neural network to improve the network's classification or prediction accuracy. When the neural network has been trained, the weights have achieved their final values. Layers and groups of consecutive layers are herein referred to as blocks. The blocks of FIG. 5 and FIG. 6 represent different layers or blocks of layers of the presented neural networks.

A neural network 500 shown in FIG. 5 may comprise an input layer 501. The input layer 501 may receive the (training) image data encoded in the first color space. The neural network may further comprise a color transformation block or layer 502 that is configured to cause the color transformation, from the first color space to a second color space, to the (training) image data. The input layer 501 and/or the color transformation layer 502 may comprise 1×1 convolution kernels, as illustrated by blocks 530 and 531, respectively.

Block 503 of the neural network 500 may comprise a convolutional layer that is followed by a Rectified Linear Unit (ReLU) activation layer and a batch normalization layer. Block 503 may form a first convolutional stack. Block 503 may have dimensions 224×224×64, wherein the first dimension represents the width (224) of the layer, the second dimension represents the height (224) of the layer, and the third dimension represents the number of channels (64) in the layer. Block 504 may be a pooling layer, such as a maximum pooling layer. Blocks 505 and 506 may form a second convolutional stack, each block 505, 506 comprising a convolutional layer followed by a ReLU layer and a batch normalization layer. The dimensions of blocks 504-506 may be 112×112×128, for example. The second convolutional stack may be followed by a (maximum) pooling layer 507. Blocks 508-510 may form a third convolutional stack, each block 508-510 comprising a convolutional layer followed by a ReLU layer and a batch normalization layer. The dimensions of blocks 507-510 may be 56×56×256, for example. The third convolutional stack may be followed by a (maximum) pooling layer 511. Blocks 512-514 may form a fourth convolutional stack, each block 512-514 comprising a convolutional layer followed by a ReLU layer and a batch normalization layer. The dimensions of blocks 512-514 may be 28×28×512, for example. The fourth convolutional stack may be followed by a (maximum) pooling layer 515. Blocks 516-518 may form a fifth convolutional stack, each block 516-518 comprising a convolutional layer followed by a ReLU layer and a batch normalization layer. The dimensions of blocks 516-518 may be 14×14×512, for example. The fifth convolutional stack may be followed by a (maximum) pooling layer 519. The neural network 500 may further comprise fully connected layers 520, 521 and 522. Layers 520 and 521 may have dimensions 1×1×4096, and layer 522 may have dimensions 1×1×2, for example. The neural network may further comprise a classification layer 523, which may be a softmax layer. The softmax layer may output the classification of the (training) image data, i.e. whether it is considered authentic or fraudulent. Blocks 503-523 may together form a classifier or authenticator block 540 of the neural network 500. The authenticator block 540 is also a neural network as such.

The training of the neural network comprising the color transformation block comprises adjusting 404 (see FIG. 4) weights of the color transformation block of the neural network. Training the neural network may be performed using supervised or unsupervised learning methods, for example. The ReLU layers, maximum pooling layers, batch normalization layers, and/or softmax layers may not comprise weights. I.e., only the weights of convolutional layers may be adjusted. The adjusting may be performed using various techniques, such as optimization algorithms like gradient descent. The training and/or adjusting the weights may be performed to maximize the accuracy and/or to minimize the error rate of the authentic/fraudulent classifications made by the neural network. The training, including adjusting the weights may be finished when the training data has been exhausted, or the performance of the neural network meets a performance criterion, such as 95% classification accuracy, for example.

In an embodiment, the color transformation block consists of one color transformation layer. In the neural network 500 of FIG. 5 this may be the color transformation layer 502. The training of the neural network may thus comprise adjusting weights of the color transformation layer 502. For example, the weights of each convolutional kernel 531 of layer 502 may be adjusted. The color transformation to be applied on the image data is learned by the color transformation block or the single color transformation layer of the neural network during the training. A single layer may be computationally very efficient both during the training and in use when classifying real image data.

The training of the neural network further comprises adjusting 408 (see FIG. 4) weights of the authenticator block 540. This may include adjusting the weights of some of the blocks 503-523 of the authenticator block. The authenticator block, being a classifier, is thus taught at the same time as the color transformation block, using the same training image data. The color transformation block and the classifier for performing the method of FIG. 3 may be obtained from or as the trained neural network 500 of FIG. 5. When the classifying of the method of FIG. 3 is performed by the trained neural network 500 of FIG. 5 that was used to train the color transformation block 502, the classifying may be performed by the authenticator block 540 of the trained neural network 500. The trained neural network 500 may thus be used for image authentication as such, as it provides means for both the color transformation (the color transformation block 502) and for classifying the transformed image data as authentic or fraudulent (the authenticator block 540).

FIG. 6 illustrates embodiments of a neural network 600. The neural network 600 may comprise an input layer 601. The input layer 601 may receive the (training) image data encoded in the first color space. The neural network 600 may further comprise a color transformation block or layer 602 that is configured to cause the color transformation, from the first color space to a second color space, to the (training) image data. The color transformation layer may accept 3-channel inputs and output 6-channel outputs, for example. In this case, the number of channels of the second color space (6) is greater than the number of channels of the first color space (3). Block 603 may comprise a convolutional layer that is followed by a ReLU layer and a batch normalization layer. The input layer 601, the color transformation layer 602, and/or the convolutional layer of block 603 may comprise 1×1 convolution kernels, as illustrated by blocks 630, 631, and 632, respectively. Block 604 represents a classification layer configured to output the classification of the (training) image data, i.e., whether it is considered authentic or fraudulent. The classification layer 604 may be a softmax layer. The classification layer 604 and layer 603 of the neural network 600 may form an authenticator block of the neural network 600.

The training of the neural network 600 comprises adjusting 404 (see FIG. 4) weights of the color transformation block or layer 602 of the neural network 600. For example, the weights of each convolutional kernel 631 of layer 602 may be adjusted. The training further comprises adjusting 408 (see FIG. 4) weights of the authenticator block. For example, the training may include adjusting the weights of block 603 of the authenticator block. For example, the weights of each convolutional kernel 632 of layer 603 may be adjusted. The authenticator block, being a classifier, is thus taught at the same time as the color transformation block, using the same training image data.

The color transformation block 602 and the classifier for performing the method of FIG. 3 may be obtained from or as the trained neural network 600 of FIG. 6. When the classifying of the method of FIG. 3 is performed by the trained neural network 600 of FIG. 6 that was used to train the color transformation block 602, the classifying may be performed by the authenticator block 603, 604 of the trained neural network 600.

FIG. 6 also illustrates further neural networks 650 and 680. In FIG. 6, neural network 680 may be an authenticator block that forms a part of the neural network 650. The structures of neural networks 650 and 680 may be the same or similar to those of neural networks 500 and 540 of FIG. 5, respectively. For example, neural network 650 of FIG. 6 may comprise an input layer 651 and a color transformation layer 652. Further structures (blocks) of the neural networks 650 and 680 may be the same or similar to those of the neural networks 500 and 540 of FIG. 5. Since the structures of the neural networks 500 and 540 of FIG. 5 have already been described above, the description is not repeated herein for neural networks 650 and 680 of FIG. 6 to avoid obscuring the disclosure.

As discussed earlier, the color transformation block of a trained neural network may be combined with another classifier for performing the method of FIG. 3. For example, the color transformation block 602 of the neural network 600 may be combined with another classifier. As an example, the neural network 600 of FIG. 6 may be trained to optimize the weights of the color transformation block 602. The weights of the color transformation block 602 may be fixed to prevent further adjustment of said weights. The color transformation block 602 may be inserted to the (untrained) neural network 650 to act as the color transformation block 652 of the neural network 650. Then, the second neural network 650 may be trained, but without adjusting the weights of the color transformation block 652 (as its weights are fixed). Training the second neural network 650 may comprise adjusting the weights of the authenticator block 680, for example. The neural network 600 and the second neural network 650, 680 are thus trained independently of each other. Training of the second neural network 650, 680 may be performed using the same or different training image data as used in the training of the neural network 600.

When the classifying of the method of FIG. 3 is performed by a second neural network trained to classify image data as authentic or fraudulent, the second neural network may be the neural network 650 or the authenticator block 680 of FIG. 6. The second neural network may have been trained separately from or independently of the (training of the) neural network 600 of FIG. 6 used for training the color transformation block 602 as described in the above paragraph.

In an embodiment, the authenticator block 603, 604 is configured to classify each pixel of a plurality of pixels of a training image as authentic or fraudulent. The classification layer may perform the classification individually for each pixel of (at least a part of) the training image data during the training. This may be implemented by each neuron or node 633 of the authenticator block/classification layer 604 being configured to output an authentic or fraudulent classification. A classification of authentic (‘Real’ in FIG. 6) or fraudulent (‘Fake’ in FIG. 6) may then be output by the neural network for each pixel classified. The classifications of each pixel may be further aggregated to obtain one classification (fraudulent or authentic) for the training image, e.g., by a further layer(s) of the neural network.

Similarly, when using the trained neural network for image authentication, the authenticator block 604 may be configured to classify each pixel of a plurality of pixels of the image data as authentic or fraudulent. The authenticator block may perform the classification individually for each pixel of (at least a part of) the image data. This may be implemented with each neuron or node 633 of the authenticator block/classification layer 604 being configured to output an authentic or fraudulent classification. The classifications of each pixel may be further aggregated to obtain one classification (fraudulent or authentic) for the input image data, e.g., by a further layer of the neural network.

The above embodiments related to pixel classification are applicable irrespective of whether the pixels of the (training) image data input to the neural network(s) are raw or derived pixels. A raw pixel herein refers to a pixel originating from a single physical element of a camera sensor. A derived pixel refers to a pixel that has been acquired by processing one or more raw pixels. The processing may comprise pixel binning, for example. Therefore, the above-mentioned pixel classification strategies need not but may classify each raw pixel of the (training) image data. Alternatively, or additionally, each derived pixel of the (training) image data may be classified.

In an embodiment, the nodes/kernels of the color transformation layer 502 (see FIG. 5), 602 (see FIG. 6) are identical. The weights of each node/kernel of the color transformation layer may be identical. The (weights of) each node/kernel may be identical in the trained neural network. As a result, the same color transformation may be applied to each pixel of the (training) image data. During image authentication, the color transformation may be applied to the image data using a transfer function (i.e., the color transformation function) that is applied to each pixel of the image data. The color transformation block therefore may be but need not be in the form of a layer. Instead, the color transformation block may comprise the transfer function that is applied to each pixel of the image data. The transformation function may be in the form of formulas or equations such as Equation 1, for example.

The method of FIG. 4 further comprises outputting 406 the trained neural network. The outputting may comprise storing the trained neural network and/or the color transformation block to the at least one memory of the apparatus. For example, when the method is performed by the server 14 of FIG. 1, the server may store the trained neural network and/or the color transformation block in the at least one memory of the server 14. The server 14 may subsequently perform image authentication according to the method of FIG. 3 using the trained neural network and/or the color transformation block. Alternatively, or additionally, the outputting may comprise transmitting the trained neural network and/or the color transformation block e.g., via the network 16 (see FIG. 1) and/or by the network interface 102 (see FIG. 2). For example, when the method is performed by the server 14 of FIG. 1, the server 14 may transmit the trained neural network and/or the color transformation block to the user device 12 e.g., via the network 16 and/or by a network interface of the server 14. The user device 12 may receive the trained neural network and/or the color transformation block via the network 16 and/or by a network interface of the user device 12, and subsequently use the trained neural network and/or the color transformation block to perform image authentication according to the method of FIG. 3.

It is noted that delivering the trained neural network and/or the color transformation block from the apparatus used for the training to the apparatus performing the method of FIG. 3 is not a mandatory step of either method described herein. The trained neural network and/or the color transformation block may be manually obtained from the apparatus used for the training according to the method of FIG. 4 and provided to the apparatus performing the method of FIG. 3.

If desired, the different functions discussed herein may be performed in a different order and/or concurrently with other. Furthermore, if desired, one or more of the above-described functions and embodiments may be optional or may be combined.

The embodiments and features, if any, described in this specification that do not fall under the scope of the independent claims are to be interpreted as examples useful for understanding various embodiments of the invention.

It is also noted herein that while the above describes example embodiments, these descriptions should not be viewed in a limiting sense. Rather, there are several variations and modifications, which may be made without departing from the scope of the present disclosure as defined in the appended claims.

1. A method for image authentication, the method comprising:
Obtaining image data encoded in a first color space;
Transforming the image data to a second color space using a color transformation block, wherein the color transformation block has been trained, using training image data comprising a plurality of training images, as part of a neural network configured to classify each training image of the training image data as authentic or fraudulent;
classifying the transformed image data as authentic or fraudulent; and
outputting the authentic or fraudulent classification of the image data.

2. The method of claim 1, wherein the image data is biometric image data depicting a biometric sample, and wherein each training image used to train the color transformation block depicts an authentic or a fraudulent biometric sample.

3. The method of claim 1, wherein the classifying is performed by the neural network that was used to train the color transformation block.

4. The method of claim 1, wherein the classifying is performed by a second neural network trained to classify image data as authentic or fraudulent, wherein the second neural network has been trained separately from the neural network.

5. The method of claim 1, wherein the transforming comprises applying one or more linear transformations to each pixel of the image data.

6. The method of claim 1, wherein a number of channels of the second color space is greater than or equal to a number of channels of the first color space.

7. The method of claim 1, wherein the image data comprises visible spectrum image data and near-infrared image data.

8. A method for providing an image authenticator, the method comprising:
obtaining training image data comprising a plurality of training images, wherein the training image data is encoded in a first color space;
training a neural network using the training image data, wherein the neural network comprises:
a color transformation block configured to cause a color transformation from the first color space to a second color space, and
an authenticator block configured to classify each training image of the training image data as authentic or fraudulent;
wherein the training comprises adjusting weights of the color transformation block and the authenticator block of the neural network; and
outputting the trained neural network.

9. The method of claim 8, wherein each training image of the training image data depicts an authentic or a fraudulent biometric sample.

10. The method of claim 8, wherein the color transformation block consists of one color transformation layer, and wherein the training comprises adjusting weights of the color transformation layer.

11. The method of claim 8, wherein the authenticator block is configured to classify each pixel of a plurality of pixels of a training image as authentic or fraudulent.

12. An apparatus for image authentication, the apparatus comprising at least one processor, at least one memory including computer program code, the at least one memory and the computer program code configured to, with the at least one processor, cause the apparatus to perform:
obtaining image data encoded in a first color space;
transforming the image data to a second color space using a color transformation block, wherein the color transformation block has been trained, using training image data comprising a plurality of training images, as part of a neural network configured to classify each training image of the training image data as authentic or fraudulent;
classifying the transformed image data as authentic or fraudulent; and
outputting the authentic or fraudulent classification of the image data.

13-15. (canceled)
